(19) United States
(12) Patent Application Publication
(10) Pub. No.: US 2002/0137501 A1
(43) Pub. Date: Sep. 26, 2002

(54) Systems and methods for wireless memory programming

(76) Inventors: Rajendra Datar, Pune (IN); Manoj Soman, Pune (IN); Sachin Ghanekar, Pune (IN)

Correspondence Address: James J. Murphy, Esq., 5400 Reanissance Tower, 1201 Elm, Dallas, TX, 74270, US

(21) Appl. No.: 09/816,538

(22) Filed: Mar. 23, 2001

(51) Int. Cl. H04M 3/00

(52) U.S. Cl. 455/419; 455/68; 455/186.1

(57) ABSTRACT

A system 200 for remotely programming a memory 205 includes a host system 201 for developing a set of code. A wireless transmitter 202 is associated with host system 201 for transmitting the code and a wireless receiver 206 is associated with memory 205 for receiving the transmitted code. System 200 further includes circuitry for storing the code received by wireless receiver 206 in memory 205.

### FIELD OF INVENTION

The present invention relates in general to electronic memories and in particular to systems and methods for wireless memory programming.

### BACKGROUND OF INVENTION

Most state of the art systems performing relatively complex functions operate as a package of hardware, software and firmware. Typically, these systems are based on one or more processors, such as microprocessors, digital signal processors (DSPs), microcontrollers and similar special purpose engines operating in response to a set of code provided in the form of software and/or firmware. It is this programmability through the software and firmware that gives processor-based systems one of their major advantages, namely, flexibility.

Through the programming and reprogramming of software and/or firmware, a system of basic hardware can be adapted to operate in a wide range of applications. Moreover, software and firmware can be more easily be changed or updated than can generally be done with hardware. For example, programmability allows for the correction bugs (in hardware, software or firmware), the update of system capabilities as the technology develops, or even a complete change in system operation.

Firmware is normally stored in internal or external non-volatile memory. This includes permanently programmed memory, such as electrically-programmable read only memory (EPROMs), or erasable non-volatile memory, such as Flash ROM. Firmware typically consists of encoded instructions and data which the average user should not need to modify once the system has left the factory, such as the BIOS, security code, constants, as well as fixed application code. The firmware survives no matter the system power-on state, usually is faster to access than software downloaded into RAM, and is more immune from tampering or copying.

Notwithstanding the advantages of firmware, it does create challenges during the system development and update processes. For example, the updated application code may be written using a suitable hardware—software development system and then programmed into Flash ROM. This Flash ROM in turn is removed from the programming hardware and inserted into the appropriate slot or slots on the printed circuit board supporting the system hardware. The system is then run using the updated application code and system performance is evaluated. If bugs are found or further improvement in the application code is called for, the Flash ROM is removed from the board and reprogrammed with the external development system. This procedure may be repeated several times until the desired system performance is achieved.

In sum, current code development procedures are not optimal. Of particular disadvantage is the need to physically transport the Flash ROM between the development system/programming hardware and a development or production board. Not only is this time consuming and clumsy, but also increases the wear and tear on the slots and pins of the hardware involved.

### SUMMARY OF INVENTION

A system is disclosed for remotely programming a memory. It includes a host system for developing code, a wireless transmitter associated with host system for transmitting the code via a wireless link and a wireless receiver associated with the memory for receiving the transmitted code. The system further includes circuitry for storing the code received by the wireless receiver in the memory.

Advantageously, the principles of the present invention eliminate the need to physically transport the memory between the development system/programming hardware and a development or production board during testing and production. Further, a memory already disposed on a board can now be efficiently field to programmed to correct errors, update the stored firmware or even completely change the operation of the system. The inventive process of memory programming becomes less time consuming and clumsy and also reduces the wear and tear on the slots and pins of the hardware involved.

### BRIEF DESCRIPTION OF DRAWINGS

FIG. 1 is a high level functional block diagram of a system-on-a-chip (SoC); and

FIG. 2 illustrates a programming/development system embodying the present inventive concepts.

### DETAILED DESCRIPTION OF THE INVENTION

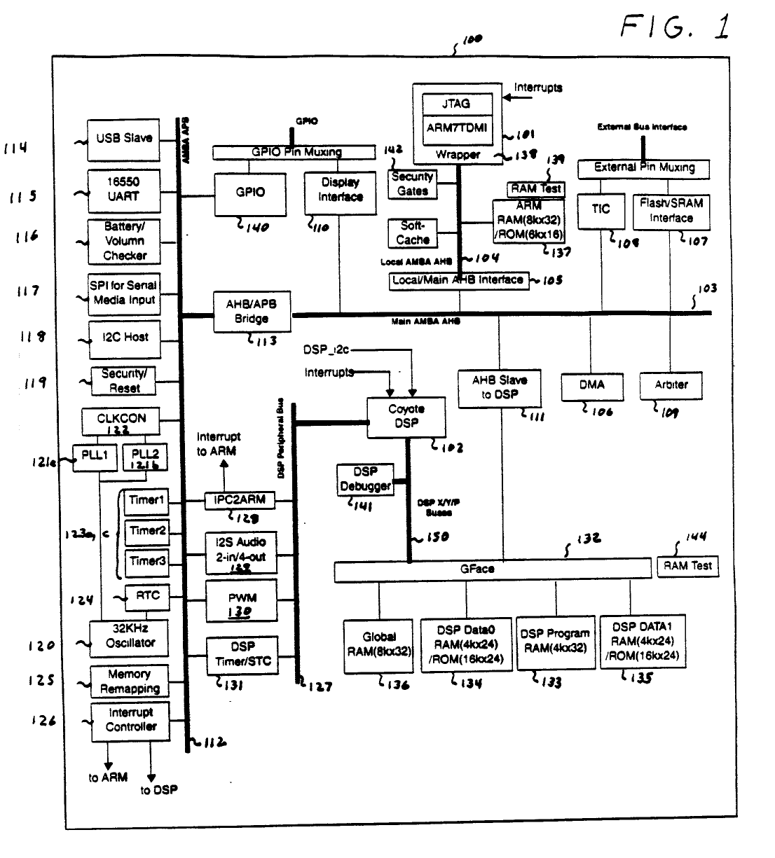

FIG. 1 is a high level functional block diagram of a system-on-a-chip (SoC) 100. SoC 100 is only one of a number of programmable systems to which the principles of the present invention can be suitably applied. Among the possible applications of system 100 are multi-standard portable audio devices processing digital audio data in such formats as MP3, MC, and MS-Audio.

System 100 includes an microprocessor 101, such as an ARM 7TDMI microprocessor, which serves various functions including interfacing the peripherals, packing and unpacking data, and acts as the system master which determines the overall function and state of the chip. Digital signal processor (DSP) 102 is a computation-intensive engine which takes dispatched data from microprocessor 101 and then decodes and controls the playback of those data through the peripheral ports.

The system bus architecture is based on ARM Advanced Microprocessor Bus Architecture (AMBA) bus system. A main or high-speed bus(AHB) bus 103 is connected to high bandwidth blocks which require more frequent access to the memory. Microprocessor 101 and its local memory (RAM/ROM) 137 operate from main bus 103 via a local AHB bus 104 and an interface 105 which bridges local AHB bus 104 and main AHB bus 103.

Among the other devices operating directly off main AHB bus 103 are a 4-channel DMA engine 106, and Flash/SRAM interface 107, including an external memory controller, which maps a block of external memory into the microprocessor memory space as an extension of on-chip memory, a test interface controller (TIC) 108, arbiter 109 and LCD interface 110. Test Interface Controller (TIC) 108 can take over the bus control from microprocessor 101 and mimic the bus cycle in order to stimulate the blocks connected to AHB/APB buses. Arbiter 109 arbitrates bus requests on main bus 103. LCD interface 110 supports connections to various LCD panels.

An AHB-DSP interface 111, which is a slave to main bus 103, allows microprocessor 101 to move data block to and from DSP memory.

System 100 also employs an AMBA Advanced Peripheral Bus (APB) 112 which links to the system low band-width peripherals. APB 112 operates from main bus 103 through AHB/APB bridge 113, which is a slave to main bus 103. The peripherals operating from APB bus 112 include a USB slave interface 114 which supports communications between system 100 and a personal computer (PC) or similar device. When system 100 is used in a portable digital music appliance, this interface enables the quick downloading files from the PC to the portable audio system. UART 115 is a serial port and provides a legacy communication channel to an associated PC at various baud rates.

Battery/Volume Checker 116 is an on-chip analog-to-digital converter (ADC) which takes two analog inputs and provides a digital signal with 8-bit precision at up to a 100 Hz sample rate for use in battery level monitoring and volume switch checking.

An SPI port 117 also operates from APB bus 112 for use with various serial storage media such as Multi-Media Card (MMC). I2C port 118 provides another common serial interface to devices such as EEPROM, DAC/Codecs and some displays. Security/Reset port 119 operates in conjunction with security code in ROM to determine the appropriate chip initialization procedure and a boot-up sequence.

A 32 KHz on-chip oscillator 120 operates in conjunction an off-chip 32.768 KHz crystal/and provides the reference clock to the on-chip PLLs 121a and 121b which provide different clocks that are needed by various blocks. Clock control is implemented through block 122 which is the main “valve” for all on-chip clock sources. Three freeruning timers 123a,c operate off APB bus 112 in support of microprocessor 101. RTC block 124 provides real time clock information for the system.

Memory Remapping 125 block comprises 3 different memory mapping schemes for different on-chip and off-chip memory configurations. Interrupt Controller 126 collects all interrupt sources and generates request to microprocessor 101 and/or DSP 102.

DSP 102 operates in conjunction with a DSP Peripheral Bus 127. Inter-Processor Communication (IPC) block 128 provides hardware for synchronization and message exchange between microprocessor 101 and DSP 102 via DSP Peripheral bus 127 and APB bus 112.

I2S In/Out block 129, which also operates off both APB bus 112 and DSP Peripheral bus 127, can be used, for example, to connect to an external ADC/DAC or transport-demuxer. Pulse width modulator (PWM) 130 provides an analog audio output. DSP Timer/STC block 131 provides timer and system timing clocks to the DSP subsystem for the purpose of synchronizing DSP routines.

GFace 132 interfaces DSP 102 with main bus 102, through slave AHB/DSP interface 111, and with the DSP memory. In the illustrated embodiment, DSP 102 is associated with dedicated on-chip Program Memory 133 and two blocks Data (Data0 and Data1) Memory 134 and 135. Global RAM 136 serves the communication buffer between microprocessor 101 and DSP 102. All DSP memories 133-135 and the Global RAM 136 are mapped into the microprocessor address space so that microprocessor 101 can initialize those memories and pass data to DSP 102. Global RAM 136 is also mapped into the DSP Program/Data0/Data1 address space, for DSP access.

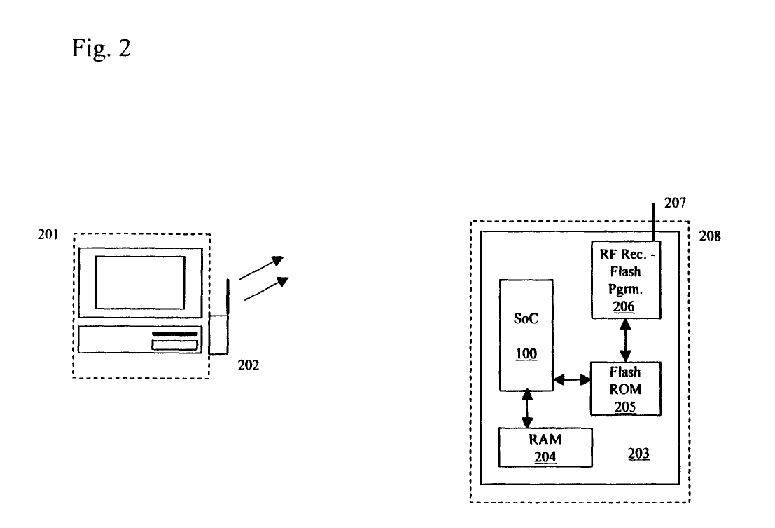

A programming/development system 200 embodying the present inventive concepts is shown in FIG. 2. System 200 is based on a host-based simulator 201 operating in response to conventional Flash ROM programming software. In FIG. 2, simulator 201 is shown as a workstation for reference. Simulator 201 is associated with wireless transmitter 202, which will be discussed in further detail below.

The programming of system 100 will be used as an example for describing the principles of the present invention. In this case, system 100 is disposed on a printed-circuit board 203, which can either be a development board or a final product board. Printed-circuit board 203 also includes volatile RAM 204 and Flash ROM 205 supporting the operation of system 100 through the external interfaces discussed above.

According to the inventive concepts, board 203 includes Flash programming circuitry-wireless receiver 206 compatible with transmitter 202 associated with simulator 201. Programming circuitry-wireless receiver 206 can be integrated, in whole or in part, into the Flash ROM chips 205 or even on to the system on a chip 100 itself. In other words, application of the present principles is not dependent on the partitioning of the programming and/or receiving circuitry between various devices.

The circuitry required to program and erase Flash ROM is known in the art, including relatively non-complex circuitry which can be integrated into Flash ROM devices 205 or system 100. Generally, this circuitry includes voltage generators for generating the programming and erasing voltages, address decoders for accessing memory locations in response to addresses generated by the development system (simulator), and data I/O for programming those locations. This circuitry can also include boot code or similar start up code in ROM for initializing the Flash programming interface and controlling general circuit operation.

The wireless link between simulator 201 and board 203 can be established using one of a number of established transmission protocols. For example, an RF link can follow the Blue Tooth or IEEE 802.11 protocols while an IR link can follow the IRDA (Infrared Data Association) Serial IR protocol. The hardware and software required to establish these links are known in the art.

Notwithstanding the transmission protocol, the data itself can be can be formatted to emulate a wired-interface between simulator 201 and board 203. Among the possible formats are the common bus interface formats such as RS232, USB, PCI, IEEE 1394 or I2C. Use of a specific data protocol allows the hardware and software available in simulator 201 to be exploited without significant change. Notwithstanding, the data being transmitted to the Flash programming circuitry need not be in a specific format. Advantageously, all that is required is the generation by simulator 201 of the requisite data along with the addresses to the locations in which the data are to be written. Any remaining control signals are then generated at the programming circuitry of block 205.

In any case, some level of encryption/decryption capability can be implemented to secure the wireless link between simulator 201 and board 203. This feature, among other things, will prevent unauthorized tampering with, copying, reprogramming or destruction of the firmware programmed into Flash memory after it leaves the factory.

To program or reprogram Flash ROM 205, the desired code is written and debugged on simulator 201 in the traditional manner. Once completed, the current version of the code including data, instruction and addresses, is transmitted via the wireless link to board 203. Prior to this, a command may be transmitted from simulator 201 initiating an erase operation of Flash memory 205 by the application of the necessary erase voltage by programming circuitry 206. As the code is received, the addresses are decoded and the data programmed into the corresponding memory locations by wireless receiver—Flash programming circuitry 206.

Following programming of Flash memory 205, system 100 is ready for test or normal operation. During test, the system composed of system-on-a-chip 100, Flash ROM 205 and RAM 204 is run to verify compliance with the complete product specifications. If errors are encountered or the ability to improve system performance arises, the wireless programming procedure discussed above is repeated as necessary.

Advantageously, the contents of the Flash ROM can be updated, debugged or even completely replaced without removing the Flash ROM from its slot on the board. Not only does this feature of the invention generally make Flash ROM programming/reprogramming more convenient, but also minimizes the wear and tear on the Flash devices and the printed-circuit board.

Another advantage of the present wireless programming system is the ability to field-program a Flash ROM based system without the burden of cables or a similar physical interconnection. Advantageously, if an external RF antenna or IR window, shown generally at 207 in FIG. 2, is provided, then board 203 can remain within its cabinet or packaging, shown generally at 208 for reference, during the programming or reprogramming process.

While a particular embodiment of the invention has been shown and described, changes and modifications may be made therein without departing from the invention in its broader aspects, and, therefore, the aim in the appended claims is to cover all such changes and modifications as fall within the true spirit and scope of the invention.

What is claimed is:

1. A system for remotely programming a memory comprising:
a host system for developing code;
a wireless transmitter associated with the host system for transmitting the code;
a wireless receiver associated with the memory for receiving the transmitted code; and
circuitry for storing the received code in the memory.

2. The system of claim 1 wherein the memory comprises Flash memory.

3. The system of claim 1 wherein the wireless transmitter comprises an RF transmitter and the wireless receiver comprises an RF receiver.

4. The system of claim 1 wherein the wireless transmitter comprises an IR transmitter and the wireless receiver comprises an IR receiver.

5. The system of claim 1 wherein the wireless transmitter transmits the code in a format emulating a wired connection between the host system and the circuitry for storing.

6. The system of claim 1 wherein the circuitry for storing the received code is integrated with the memory.

7. The system of claim 1 wherein the wireless receiver is integrated with the memory.

8. A system comprising:
a processor operating in response to code programmed into an associated Flash memory;
a wireless receiver for receiving the code from a remote development system; and
circuitry for programming the code received by the wireless receiver into the Flash memory.

9. The system of claim 8 wherein the processor and the flash memory are disposed on a development board.

10. The system of claim 8 wherein the processor and the flash memory are disposed on a production board.

11. The system of claim 8 wherein the processor forms a portion of a system-on-a-chip.

12. The system of claim 8 wherein the circuitry for programming is integrated with the flash memory.

13. The system of claim 11 wherein the circuitry for programming is integrated into the system-on-a-chip.

14. The system of claim 8 wherein the flash memory is disposed in an enclosure including means for providing the code to an input of the wireless receiver.

15. A method of remotely programming a memory associated with a wireless receiver and circuitry for storing code received by the wireless receiver in the memory comprising the steps of:
developing the code on a simulation system;
transmitting the code via a wireless link from the simulation system to the wireless receiver associated with the memory; and
storing the code in the memory.

16. The method of claim 15 wherein said step of transmitting comprises the substep of formatting the code into a format emulating a wired connection between the simulation system and the memory.

17. The method of claim 16 wherein the format is selected from the group comprising the PCI, RS232, IEEE 1394, USB and I2C bus protocols.

18. The method of claim 15 wherein said step of transmitting comprises the step of transmitting the code via an RF wireless link.

19. The method of claim 15 wherein said step of transmitting comprises the step of transmitting the code via an IR wireless link.

20. The method of claim 15 and further comprising the step of erasing the memory of previously stored code prior to said step of transmitting.
